(19) United States
(12) Patent Application Publication
(10) Pub. No.: US 2008/0168045 A1
(43) Pub. Date: Jul. 10, 2008

(54) CONTENT RANK

(75) Inventors: Dzmitry Suponau, Bellevue, WA (US); Eric L. Burns, Seattle, WA (US); Harry Kaplanian, Mercer Island, WA (US); Jay R. Girotto, Kirkland, WA (US); Jon Michael Buschman, Seattle, WA (US); Philip Ti-Fei Su, Kirkland, WA (US); Yue Liu, Issaquah, WA (US); Zarah Johnson-Morris, Seattle, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/621,736

(22) Filed: Jan. 10, 2007

(51) Int. Cl. G06F 17/30

(52) U.S. Cl. 707/5; 707/E17.119

(57) ABSTRACT

The claimed subject matter provides a system and/or a method that facilitates generating a content rank that includes at least one quantitative measurement to ascertain the importance of a literary work and/or media. An interface component can receive data related to a query. A rank component can employ a content rank based on a quantitative measurement to ascertain an objective ranking of the queried content.

### BACKGROUND

In many instances, a search engine is utilized to search for information. In general, a search engine is a special program (e.g., computer executable instructions) designed to help find files (e.g., web pages, images, text . . . ) stored on a computer, for example, a public server or on one's own personal computer. A typical search engine allows a user to invoke a query for files that satisfy particular criteria, for example, files that contain a given word or phrase in a title or body. Web search engines generally work by storing information about a large number of web pages retrieved from the World Wide Web (WWW) through a web crawler, or an automated web browser, which follows essentially every link it locates. The contents of each web page are then analyzed to determine how it should be indexed, for example, words can be extracted from the titles, headings, or special fields called meta-tags. Data about web pages is stored in an index database for use in later queries. Some search engines store (or cache) all or part of a source page as well as information about the web pages. When a user invokes a query through the web search engine by providing key words, the web search engine looks up the index and provides a listing of web pages that best-match the criteria, usually with a short summary containing the document's title and/or parts of the text.

In general, the usefulness of a search engine depends on the relevance of the results it presents to a user and the presentation of such results. While there can be numerous web pages that include a particular word or phrase, some web pages may be more relevant, popular, or authoritative than others. Most search engines employ methods to rank the results to provide a “best” result first. How a search engine decides which pages are the best matches, and what order the results should be shown in, varies widely from one engine to another. Conventionally, the technique for displaying what the search engine considers relevant information about a web page to a user can based solely on traffic. In other words, query results are traditionally ranked based on the number of links and the traffic associated with such links. Thus, a particular web page can be ranked very high solely because a link within such web page has a relatively high amount of traffic. Utilizing the page structure of web pages to prioritize query results is not an efficient and/or user specific technique.

As of late, there is an increase and rapid movement toward gathering and indexing non-web content by search engines to allow access and availability via the Internet. In particular, literary works (e.g., books, periodicals, articles, newspapers, magazines, manuals, etc.) and media (e.g., music, video, etc.) are an area where much work occurs, wherein content by the millions are scanned and hosted by major search portals with little or no end in sight. A typical problem associated with gathering such massive amounts of data is the ability of a user to ascertain which of the literary works and/or media presented in search results are relevant and/or applicable to a query/search. Conventional search systems can rank and present search results in an algorithmic order that tends to be somewhat useful to the user, yet the algorithm is completely unaware of the validity/accuracy of respective hyperlinks (e.g., used to determine importance and/or relevancy). Such conventional search systems can be an inefficient manner for querying data and related content. Moreover, ascertaining the importance of a literary work in the absence of hyperlinks can be difficult and/or inaccurate.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

The subject innovation relates to systems and/or methods that facilitate generating a content rank that includes at least one quantitative measurement to ascertain the importance of a literary work and/or media. A rank component can receive data related to a query aimed at specific content, wherein the rank component can create a content rank based on a quantitative measurement to enable an objective criteria associated with content. The content rank can correspond to any data that can be queried such as books, periodicals, newspapers, articles, music, media, movies, video, comic books, manuals, and the like.

The rank component can employ at least one quantitative measurement to provide the arrangement of data in a set order. The content rank created utilizing the quantitative measurement can provide a scalable and objective rank utilizing quantitative measurements relating to the importance of such content. In particular, the content rank can be independent of traditional hyperlink-based ranking techniques. However, the content rank can be utilized in conjunction with traditional hyperlink-based ranking techniques in order to enhance data querying.

In accordance with one aspect of the claimed subject matter, the rank component can utilize an update component that enables continuous and seamless versioning of at least one quantitative measurement utilized to create the content rank. In general, the update component can employ versioning associated with quantitative measurements in order to ensure that the optimal measurement is implemented to create the content rank. In other words, the update component can continuously upgrade the quantitative measurement(s) in light of any changes and/or adjustments associated therewith. In other aspects of the claimed subject matter, methods are provided that facilitate querying content by employing a content rank utilizing quantitative measurements.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates generating a content rank that includes at least one quantitative measurement to ascertain the importance of a literary work and/or media.

FIG. 2 illustrates a block diagram of an exemplary system that facilitates creating a content rank utilized with querying data.

FIG. 3 illustrates a block diagram of an exemplary system that facilitates querying content by employing a content rank utilizing quantitative measurements.

FIG. 4 illustrates a block diagram of an exemplary system that facilitates updating quantitative measurements utilized to generate a content rank related to literary works and/or media.

FIG. 5 illustrates a block diagram of exemplary system that facilitates utilizing a content rank to ascertain the importance of various queried content.

FIG. 6 illustrates a block diagram of an exemplary system that facilitates generating a content rank for queried data based upon a user's preference.

FIG. 7 illustrates an exemplary methodology for generating a content rank that includes at least one quantitative measurement to ascertain the importance of a literary work and/or media.

FIG. 8 illustrates an exemplary methodology that facilitates querying literary works and/or media by employing a content rank utilizing quantitative measurements.

FIG. 9 illustrates an exemplary networking environment, wherein the novel aspects of the claimed subject matter can be employed.

FIG. 10 illustrates an exemplary operating environment that can be employed in accordance with the claimed subject matter.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

As utilized herein, terms “component,” “system,” “engine,” “interface,” and the like are intended to refer to a computer-related entity, either hardware, software (e.g., in execution), and/or firmware. For example, a component can be a process running on a processor, a processor, an object, an executable, a program, a function, a library, a subroutine, and/or a computer or a combination of software and hardware. By way of illustration, both an application running on a server and the server can be a component. One or more components can reside within a process and a component can be localized on one computer and/or distributed between two or more computers.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter. Moreover, the word “exemplary” is used herein to mean serving as an example, instance, or illustration. Any aspect or design described herein as “exemplary” is not necessarily to be construed as preferred or advantageous over other aspects or designs.

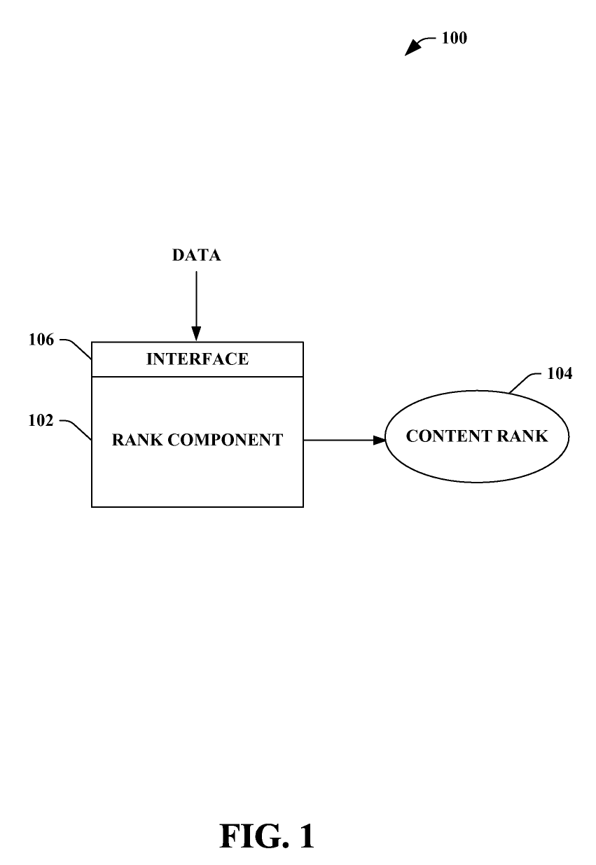

Now turning to the figures, FIG. 1 illustrates a system 100 that facilitates generating a content rank that includes at least one quantitative measurement to ascertain the importance of content (e.g., literary work, media, etc.). The system 100 can include a rank component 102 that can generate a content rank 104 correlating to at least one piece of content that can be a query result, wherein the content rank 104 provides a scalable and objective rank utilizing quantitative measurements relating to the importance of such content. In particular, the rank component 102 can receive data (e.g., query data, query results, literature, a portion of literature, media, magazine data, book data, article data, newspaper data, music data, video data, media data, movie data, literature, etc.) via an interface component 106 (discussed below) to enable the creation of the content rank 104 that provides an objective and scalable rank associated with at least a portion of content. For instance, the rank component 102 can receive query results via the interface 106 in which the query results are associated with a particular query corresponding to various content (e.g., books, magazines, newspapers, articles, periodicals, comic books, literature, media, music, video, movies, manuals, etc.). The rank component 102 can create the content rank 104 for the query result content, wherein the content rank 104 can be an objective ranking related to importance based at least in part upon a quantitative measurement.

The rank component 102 can implement the content rank 104 for any suitable content associated with query results such that the content rank 104 can be based on quantitative measurement(s) (e.g., discussed in more detail infra) independent of typical hyperlink-relevancy techniques. It is to be appreciated that a content can be, but is not limited to being, a book, a magazine, a newspaper, an article, a periodical, a comic book, a literary work, a written work, a newspaper article, a magazine article, a newspaper article, a portion of literature, a poem, a manual, a portion of data associated with literature, a portion of media, a portion of music, a movie, a portion of a movie, a video, a portion of video, and/or any other suitable portion of content that can be queried.

In order to provide the scalable and objective rank associated with content and/or any other suitable data that can be queried, the rank component 102 can employ various quantitative measurements to aid in ascertaining content importance. For instance, the content rank 104 can be an objective determining factor that can give an insight on the content's reputation based at least upon the quantitative measurement. In particular, the rank component 102 can implement at least one quantitative measurement to base the content rank 104, wherein the quantitative measurement can be, but is not limited to being, a number of web pages that mention the content (e.g., the more web pages, the more important), the importance the web pages that mention the content (e.g., the importance can be ascertained by trustworthiness, longevity, popularity, and/or industry standard for the particular content), a number of library holdings for the content (e.g., the more holdings, the more important the content), a library circulation number for the content (e.g., the higher correlates to being more important), sales data for the content (e.g., higher sales can indicate importance), a peer group review of the content, a peer group rating for the content, a popularity determination correlating to a sect of users, a number of related/residual works (e.g., book with associated plays, books created into movies, music utilized in a video, a video such as a sitcom turned into a movie, etc.), a number of unique institutional holdings (e.g., importance can be increased based if an institution has more than one copy of the content), a number of reviews, a number of creative entity holdings (e.g., a creative entity can be any suitable person associated with developing the content such as an author, composer, director, producer, actor, journalist, poet, an actress, a screen-writer, a special effects artist, an artist, a librarian, a blogger, and a photographer, etc.), a creative entity circulation number, a creative entity web mentions, a creative entity web mentions, a creative entity sales statistics, a creative entity mentioned in book indices, a relationship with a particular creative entity, newsgroup opinions, forum opinions, and/or incoming links to content. The quantitative measurements described are solely for example and it is to be appreciated that subtle changes, nuances, and/or adjustments are to be considered included in the claimed subject matter.

In addition, the system 100 can include any suitable and/or necessary interface component 106 (herein referred to as “interface 106”), which provides various adapters, connectors, channels, communication paths, etc. to integrate the rank component 102 into virtually any operating and/or database system(s) and/or with one another. In addition, the interface component 106 can provide various adapters, connectors, channels, communication paths, etc., that provide for interaction with the rank component 102, content rank 104, and/or any other component, data and the like associated with the system 100.

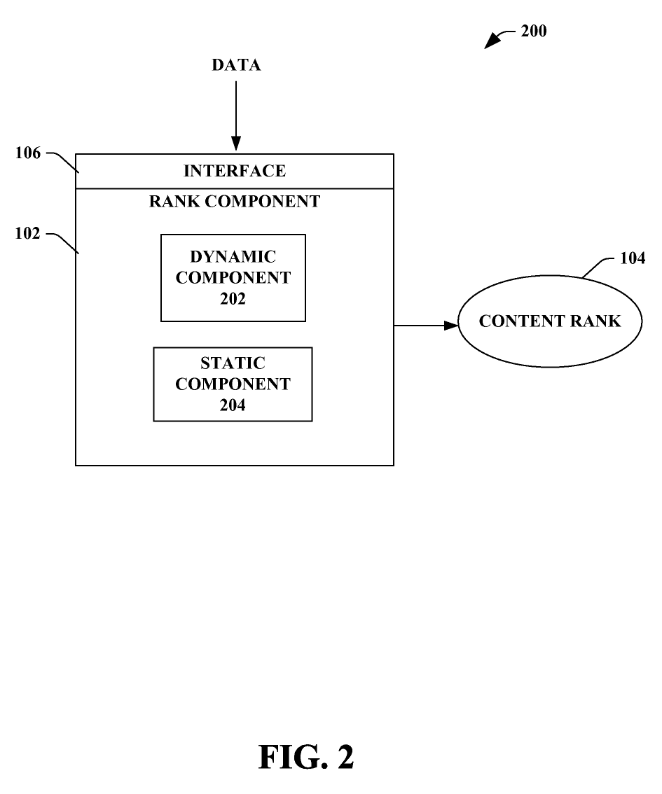

FIG. 2 illustrates a system 200 that facilitates creating a content rank utilized with querying data. The system 200 can include the rank component 102 that can generate the content rank 104 to allow for a scalable and objective manner to organize data according to importance. Specifically, the rank component 102 can employ at least one quantitative measurement to enable a determination of importance to be made regarding content (e.g., books, magazines, newspapers, articles, periodicals, comic books, literature, media, music, video, movies, manuals, etc.). Generally, the rank component 102 can provide the content rank 104 utilizing a quantitative measurement to allow an objective numerical order of content. It is to be appreciated that the quantitative measurement utilized by the rank component 102 can allow content ranking independent of traditional hyperlink-based ranking techniques.

It is to be appreciated that the rank component 102 can initiate a combination of traditional ranking (e.g., dynamic querying based on a received query) and ranking utilizing the content rank 104 (e.g., intrinsic value of content based on a quantitative measurement) as described herein. For instance, the rank component 102 can utilize a dynamic component 202 to implement dynamic querying, wherein the dynamic querying can be based upon providing content with matching query terms. Specifically, the dynamic querying can change upon each query received since each query can include changing terms, which in turn, changes the query result (e.g., content with matching query terms).

The rank component 102 can further utilize a static component 204 that provides an intrinsic value of content based at least in part upon a quantitative measurement (e.g., also referred to as the content rank 104). For instance, the static component 204 can utilize the quantitative measurement to create the content rank 104 that is objective and independent of typical and/or traditional ranking technologies and/or techniques (e.g., utilizing the number and importance of reference hyperlinks). It is to be appreciated that the quantitative measurement can be, but is not limited to being, a number of web pages that mention the content, the importance the web pages that mention the content, a number of library holdings for the content, a library circulation number for the content, sales data for the content, a peer group review of the content, a peer group rating for the content, a popularity determination correlating to a sect of users, a number of related/residual works, a number of unique institutional holdings, a number of reviews, a number of creative entity holdings (e.g., a creative entity can be any suitable person associated with developing the content such as an author, composer, director, producer, actor, journalist, poet, etc.), a creative entity circulation number, a creative entity web mentions, a creative entity web mentions, a creative entity sales statistics, a creative entity mentioned in book indices, a relationship with a particular creative entity, newsgroup opinions, forum opinions, and/or incoming links to content.

For instance, the quantitative measurement can be any suitable objective manner to hierarchically categorize data with objectivity independent of utilizing hyperlinks. In addition, the quantitative measurement can be continuously manipulated and/or managed to adapt to a particular user (e.g., a user browses data more frequently on web site A, so quantitative measurements (groups, peer reviews, and the like) relating to web site A should be held in higher regard, etc.). In another instance, the quantitative measurement can be changed based on patterns and/or characteristics of a particular user (e.g., a user prefers opinions from one group over another, etc.).

Moreover, the static component 204 allows the quantitative measurement to be static for respective content independent of the query received. Thus, regardless of the query terms received, the content produced can include the content rank 104 which provides an objective, intrinsic value of the content based on the quantitative measurement(s). For instance, a query can be received wherein results are ranked based on a score that incorporates a portion of the dynamic querying and each result can include a content rank. Thus, the querying of data can be more versatile to give a user context for the content provided as query results, wherein the context includes at least one of importance of web sites, number and importance of hyperlinks, content rank based upon a quantitative measurement, and/or any combination thereof.

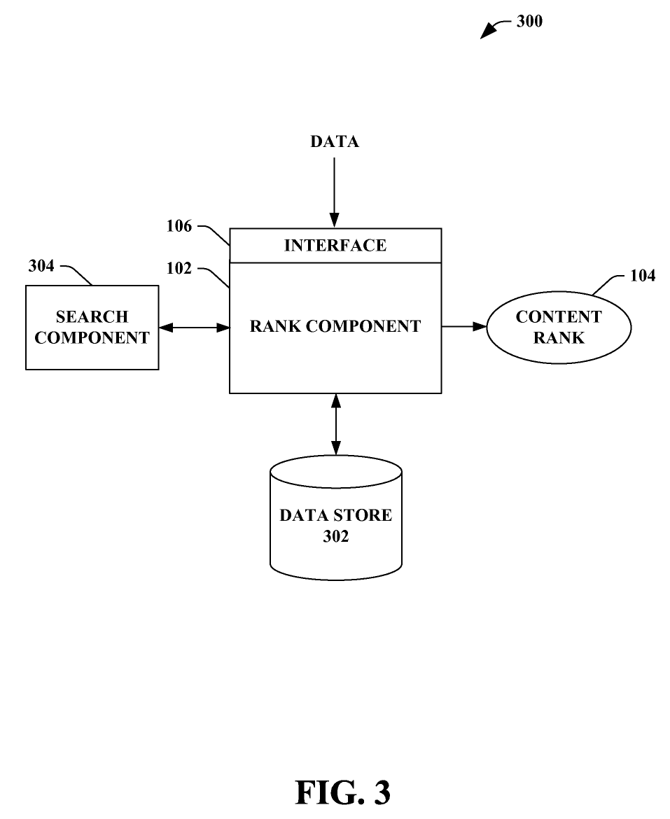

FIG. 3 illustrates a system 300 that facilitates querying data by employing a content rank utilizing quantitative measurements. The rank component 102 can create the content rank 104 to assist determining the importance thereof. For instance, the rank component 102 can employ the content rank 104 respective to each portion of content connected/produced with a query. Such content rank 104 can provide a scalable and objective ranking for literary works and/or media identified in connection with a query result. In another example, the rank component 102 can employ the content rank 104 with any query result to determine the objective importance of such literary work and/or media.

The system 300 can further include a data store 302 that can include any suitable data related to the rank component 102, and the content rank 104. For instance, the data store can include quantitative measurement data, content-related data utilized for quantitative measurements, creative entity data implemented for quantitative measurements, query data, query content, data that is queried, content, dynamic querying, static querying, user preferences, user configurations, settings, any data that can be utilized for a quantitative measurement (described above), etc. It is to be appreciated that the data store 302 can be, for example, either volatile memory or nonvolatile memory, or can include both volatile and nonvolatile memory. By way of illustration, and not limitation, nonvolatile memory can include read only memory (ROM), programmable ROM (PROM), electrically programmable ROM (EPROM), electrically erasable programmable ROM (EEPROM), or flash memory. Volatile memory can include random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM). The data store 302 of the subject systems and methods is intended to comprise, without being limited to, these and any other suitable types of memory. In addition, it is to be appreciated that the data store 302 can be a server, a database, a hard drive, and the like.

The rank component 102 can further utilize a search component 304 that facilitates querying data. In one instance, the search component 304 can receive a query and provide query results based at least in part upon the received query, wherein the rank component 102 can generate the content rank 104 for a query result pertaining to literary work, media, and/or content. In another instance, the search component 304 can provide query results to the rank component 102 to allow the rank component 102 to create content ranks 104 for any suitable query results associated with literary works. In other words, the search component 304 can receive a query and collect query results associated with such query, wherein any query result related to content can include a respective content rank 104.

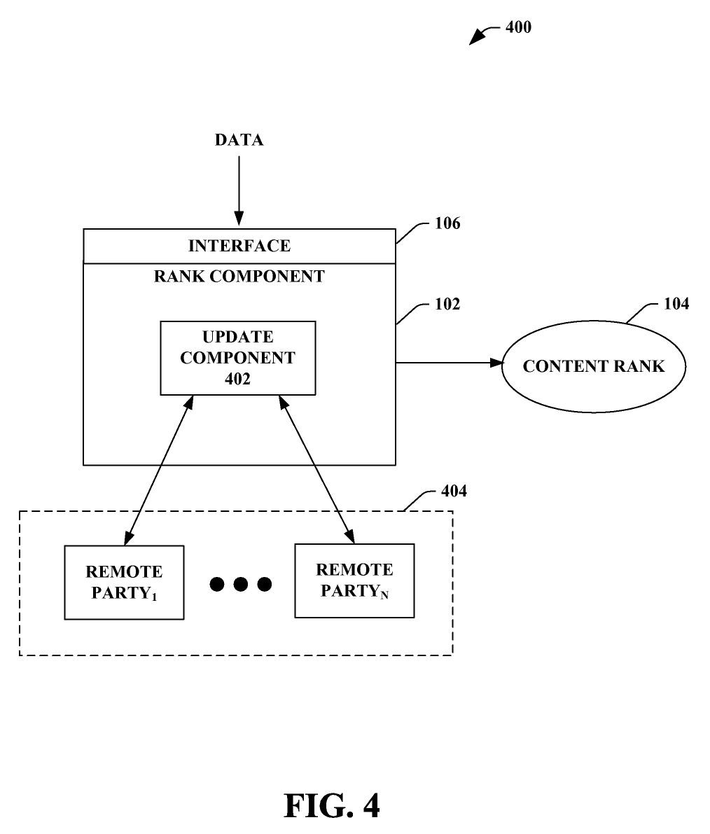

FIG. 4 illustrates a system 400 that facilitates updating quantitative measurements utilized to generate a content rank related to content. The rank component 102 can create the content rank 104 to allow an objective hierarchical categorization of query results based upon a quantitative measurement. In particular, the rank component 102 can enhance the querying of data and/or content utilizing the content rank 104 by enabling the query results to be ranked with the quantitative measurement which can be independent of the number of hyperlinks and/or importance of reference hyperlinks. In one example, the content rank 104 can be utilized with querying data in order to provide an optimized manner to query data/content. It is to be appreciated that the content can be, but is not limited to, a book, a magazine, a newspaper, an article, a periodical, a comic book, a literary work, a written work, a newspaper article, a magazine article, a newspaper article, a portion of literature, a poem, a manual, a portion of data associated with literature, a portion of media, a portion of music, a movie, a portion of a movie, a video, a portion of video, and/or any other suitable portion of content that can be queried.

The system 400 can include an update component 402 that enables continuous and seamless versioning of at least one quantitative measurement utilized to create the content rank 104. In general, the update component 402 can employ versioning associated with quantitative measurements in order to ensure that the optimal measurement is implemented to create the content rank 104. In other words, the update component 402 can continuously upgrade the quantitative measurement(s) in light of any changes and/or adjustments associated therewith. For instance, a quantitative measurement can be upgraded to a more recent version to correct defects, increase security, enhance virus protection, update characteristics related to the measurement, etc. In another example, the update component 402 can provide additional quantitative measurements not yet utilized by the rank component 102. In particular, the update component 402 can receive various third-party quantitative measurements that are specifically tailored for particular content. Thus, a remote party 404 and/or third-party service (not shown) can be utilized to provide the rank component 102 with quantitative measurements. It is to be appreciated that there can be any suitable number of remote parties 404 such as remote party₁ to remote party_{N}, where N is a positive integer.

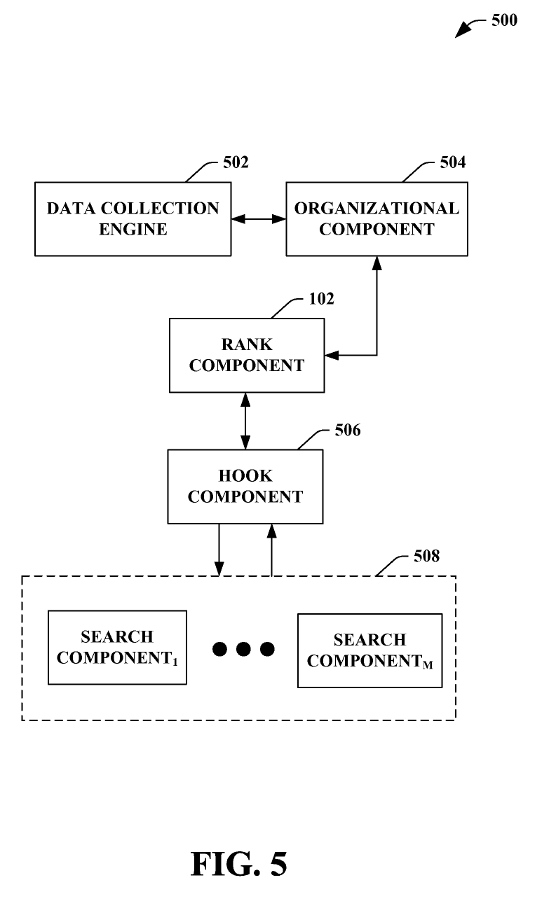

FIG. 5 illustrates a system 500 that facilitates utilizing a content rank to ascertain the importance of a literary work and/or media. The system 500 provides an objective ranking and/or hierarchical categorization of data/content independent of traditional hyperlink-based ranking techniques that utilize the number and/or importance of reference hyperlinks. The system 500 can include a data collection engine 502 that can collect and/or gather various portions of data related to content. For example, the data collection engine 502 can gather data that can be utilized for a quantitative measurement. An organizational component 504 can evaluate and organize any data collected by the data collection engine 502, wherein the data can be organized and/or normalized to allow the rank component 102 to create the content rank. The system 500 can further include a hook component 506 that allows various search components 508 to latch into the rank component 102 to enable access to the generated content rank(s). In other words, the hook component 506 can interpret queries associated with search components 508 (regardless of format, disparities, and the like between search components), wherein such queries can be executed to provide query results including content with respective content rank. It is to be appreciated that there can be any suitable number of search components 508 such as search component 1 to search component M, where M is a positive integer.

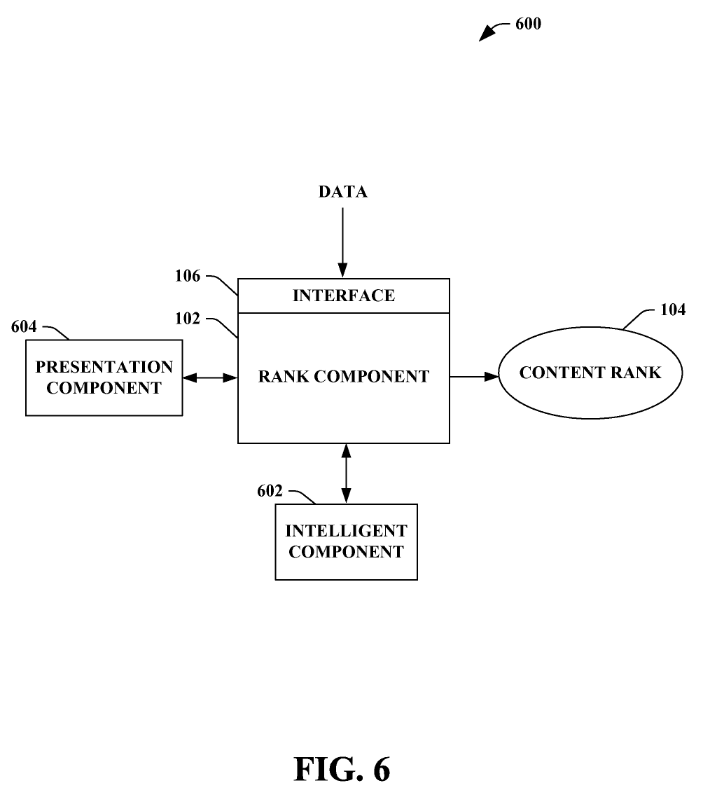

FIG. 6 illustrates a system 600 that employs intelligence to facilitate generating a content rank for literary works and/or media based upon a user's preference. The system 600 can include the rank component 102, the interface 106, and the content rank 104, wherein it is to be appreciated that the rank component 102, the content rank 104, and the interface 106 can be substantially similar to respective components, ranks, and interfaces described in previous figures. The system 600 further includes an intelligent component 602. The intelligent component 602 can be utilized by the rank component 102 to facilitate generating the content rank 104 to provide a scalable and objective ranking system associated with content identified in a query and/or query results. For example, the intelligent component 602 can infer quantitative measurements, user preferences to ascertain importance respective to the specific user, content rank, weight associated with quantitative measurements, literary work relevance, query results, query context, quantitative measurement effectiveness, identification of additional quantitative measurements, evaluation of a remote party that provides a quantitative measurement, etc.

It is to be understood that the intelligent component 602 can provide for reasoning about or infer states of the system, environment, and/or user from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

A classifier is a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that a user desires to be automatically performed. A support vector machine (SVM) is an example of a classifier that can be employed. The SVM operates by finding a hypersurface in the space of possible inputs, which hypersurface attempts to split the triggering criteria from the non-triggering events. Intuitively, this makes the classification correct for testing data that is near, but not identical to training data. Other directed and undirected model classification approaches include, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

The rank component 102 can further utilize a presentation component 604 that provides various types of user interfaces to facilitate interaction between a user and any component coupled to the rank component 102. As depicted, the presentation component 604 is a separate entity that can be utilized with the rank component 102. However, it is to be appreciated that the presentation component 604 and/or similar view components can be incorporated into the rank component 102 and/or a stand-alone unit. The presentation component 604 can provide one or more graphical user interfaces (GUIs), command line interfaces, and the like. For example, a GUI can be rendered that provides a user with a region or means to load, import, read, etc., data, and can include a region to present the results of such. These regions can comprise known text and/or graphic regions comprising dialogue boxes, static controls, drop-down-menus, list boxes, pop-up menus, as edit controls, combo boxes, radio buttons, check boxes, push buttons, and graphic boxes. In addition, utilities to facilitate the presentation such as vertical and/or horizontal scroll bars for navigation and toolbar buttons to determine whether a region will be viewable can be employed. For example, the user can interact with one or more of the components coupled and/or incorporated into the rank component 102.

The user can also interact with the regions to select and provide information via various devices such as a mouse, a roller ball, a keypad, a keyboard, a pen and/or voice activation, for example. Typically, a mechanism such as a push button or the enter key on the keyboard can be employed subsequent entering the information in order to initiate the search. However, it is to be appreciated that the claimed subject matter is not so limited. For example, merely highlighting a check box can initiate information conveyance. In another example, a command line interface can be employed. For example, the command line interface can prompt (e.g., via a text message on a display and an audio tone) the user for information via providing a text message. The user can than provide suitable information, such as alpha-numeric input corresponding to an option provided in the interface prompt or an answer to a question posed in the prompt. It is to be appreciated that the command line interface can be employed in connection with a GUI and/or API. In addition, the command line interface can be employed in connection with hardware (e.g., video cards) and/or displays (e.g., black and white, and EGA) with limited graphic support, and/or low bandwidth communication channels.

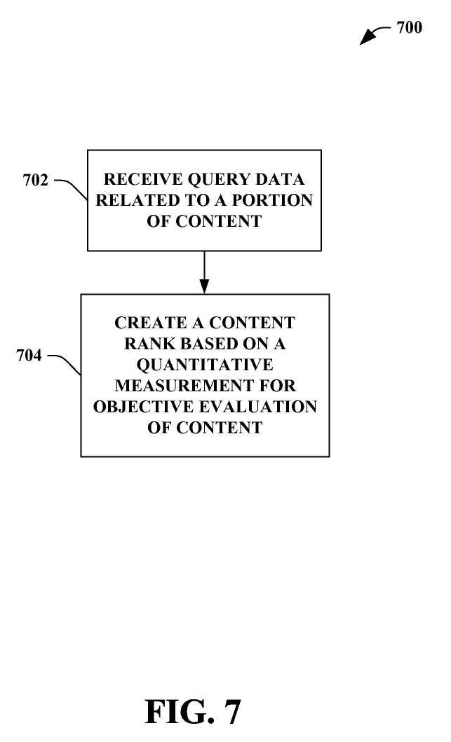

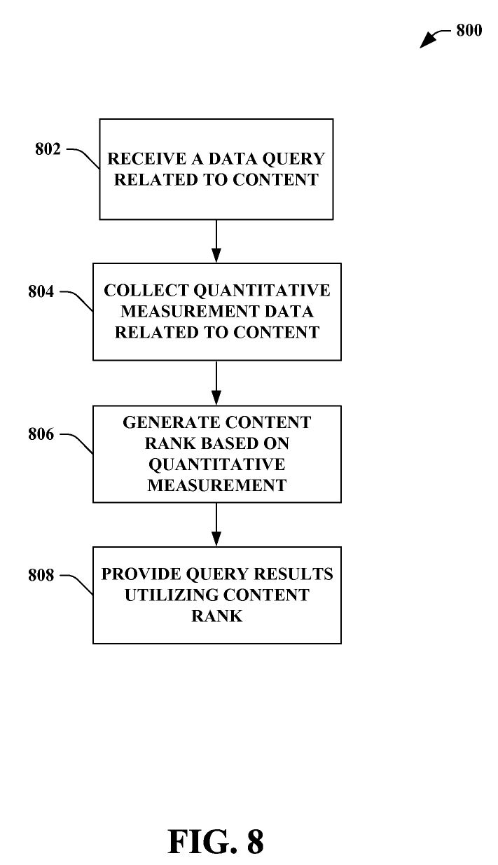

FIGS. 7-8 illustrate methodologies and/or flow diagrams in accordance with the claimed subject matter. For simplicity of explanation, the methodologies are depicted and described as a series of acts. It is to be understood and appreciated that the subject innovation is not limited by the acts illustrated and/or by the order of acts, for example acts can occur in various orders and/or concurrently, and with other acts not presented and described herein. Furthermore, not all illustrated acts may be required to implement the methodologies in accordance with the claimed subject matter. In addition, those skilled in the art will understand and appreciate that the methodologies could alternatively be represented as a series of interrelated states via a state diagram or events. Additionally, it should be further appreciated that the methodologies disclosed hereinafter and throughout this specification are capable of being stored on an article of manufacture to facilitate transporting and transferring such methodologies to computers. The term article of manufacture, as used herein, is intended to encompass a computer program accessible from any computer-readable device, carrier, or media.

FIG. 7 illustrates a methodology 700 for generating a content rank that includes at least one quantitative measurement to ascertain the importance of literary work and/or media. At reference numeral 702, query data related to a portion of content can be received. For instance, the portion of content can be, but is not limited to being, a book, a magazine, a newspaper, an article, a periodical, a comic book, a literary work, a written work, a newspaper article, a magazine article, a newspaper article, a portion of literature, a poem, a manual, a portion of data associated with literature, a portion of media, a portion of music, a movie, a portion of a movie, a video, a portion of video, and/or any other suitable portion of content that can be queried.

At reference numeral 704, a content rank can be created that can be based on a quantitative measurement for an objective evaluation of content. For instance, the content rank can be an objective determining factor that can give an insight on the content's reputation based at least upon the quantitative measurement. In particular, the quantitative measurement can be, but is not limited to being, a number of web pages that mention the content (e.g., the more web pages, the more important), the importance the web pages that mention the content (e.g., the importance can be ascertained by trustworthiness, longevity, popularity, and/or industry standard for the particular content), a number of library holdings for the content (e.g., the more holdings, the more important the content), a library circulation number for the content (e.g., the higher correlates to being more important), sales data for the content (e.g., higher sales can indicate importance), a peer group review of the content, a peer group rating for the content, a popularity determination correlating to a sect of users, a number of related/residual works (e.g., book with associated plays, books created into movies, music utilized in a video, a video such as a sitcom turned into a movie, etc.), a number of unique institutional holdings (e.g., importance can be increased based if an institution has more than one copy of the content), a number of reviews, a number of creative entity holdings (e.g., a creative entity can be any suitable person associated with developing the content such as an author, composer, director, producer, actor, journalist, poet, etc.), a creative entity circulation number, a creative entity web mentions, a creative entity web mentions, a creative entity sales statistics, a creative entity mentioned in book indices, a relationship with a particular creative entity, newsgroup opinions, forum opinions, and/or incoming links to content.

FIG. 8 illustrates a methodology 800 that facilitates querying content by employing a content rank utilizing quantitative measurements. At reference numeral 802, a data query related to content can be received. At reference numeral 804, quantitative measurement data related to the content can be collected. For example, the quantitative measurement can be, but not limited to, a number of web pages that mention the content, the importance the web pages that mention the content, a number of library holdings for the content, a library circulation number for the content, sales data for the content, a peer group review of the content, a peer group rating for the content, a popularity determination correlating to a sect of users, a number of related/residual works, a number of unique institutional holdings, a number of reviews, a number of creative entity holdings, a creative entity circulation number, a creative entity web mentions, a creative entity web mentions, a creative entity sales statistics, a creative entity mentioned in book indices, a relationship with a particular creative entity, newsgroup opinions, forum opinions, incoming links to content, and/or any other suitable quantitative measure associated with the content independent of reference hyperlinks.

At reference numeral 806, a content rank can be generated based on the quantitative measurement. Such content rank can provide a scalable and objective ranking for content (e.g., literary works, media, etc.) identified in connection with the query result corresponding to the data query. At reference numeral 808, query results can be providing utilizing the content rank. For example, the content rank can be utilized with any query result to determine the objective importance of such content. It is to be appreciated that a combination of traditional ranking (e.g., dynamic querying based on a received query) and ranking utilizing the content rank (e.g., intrinsic value of content based on a quantitative measurement) can be implemented. For instance, dynamic querying can be based upon providing content with matching query terms. Specifically, the dynamic querying can change upon each query received since each query can include changing terms, which in turn, changes the query result (e.g., content with matching query terms). The content rank can provide ranking utilizing an intrinsic value of content based at least in part upon a quantitative measurement. For instance, the quantitative measurement can facilitate creating the content rank to be objective and independent of typical and/or traditional ranking technologies and/or techniques (e.g., utilizing the number and importance of reference hyperlinks).

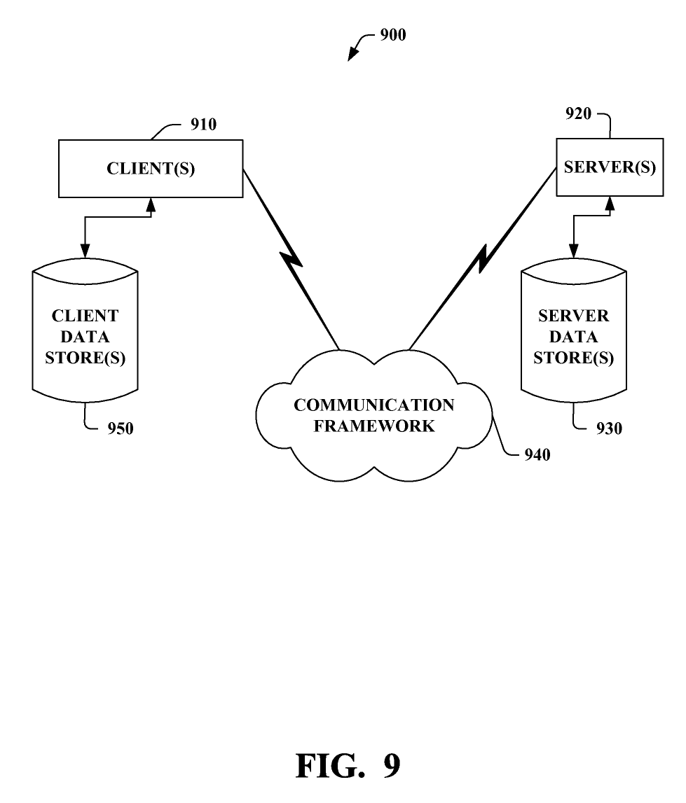

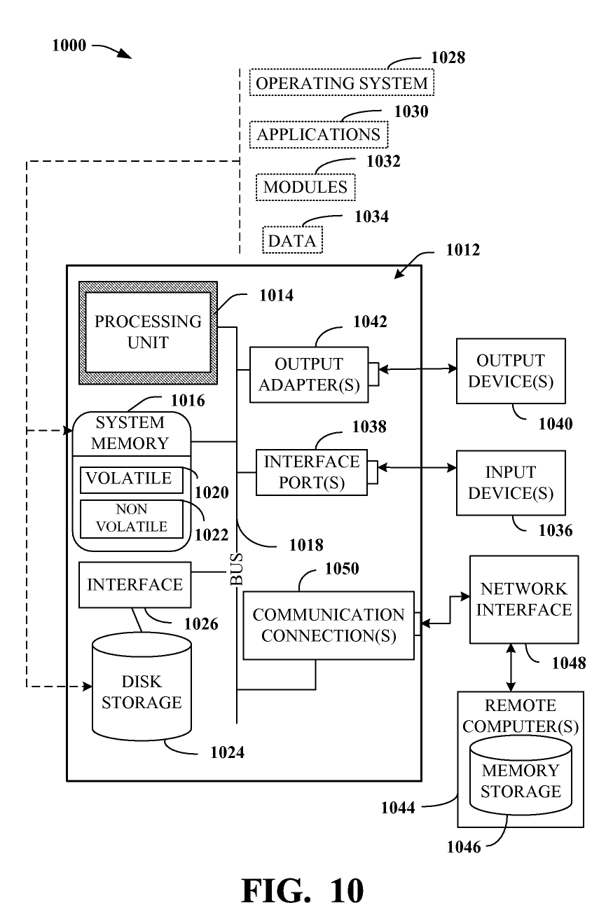

In order to provide additional context for implementing various aspects of the claimed subject matter, FIGS. 9-10 and the following discussion is intended to provide a brief, general description of a suitable computing environment in which the various aspects of the subject innovation may be implemented. For example, a rank component that facilitates generating a content rank that relates to a quantitative measurement of the importance of content, as described in the previous figures, can be implemented in such suitable computing environment. While the claimed subject matter has been described above in the general context of computer-executable instructions of a computer program that runs on a local computer and/or remote computer, those skilled in the art will recognize that the subject innovation also may be implemented in combination with other program modules. Generally, program modules include routines, programs, components, data structures, etc., that perform particular tasks and/or implement particular abstract data types.

Moreover, those skilled in the art will appreciate that the inventive methods may be practiced with other computer system configurations, including single-processor or multi-processor computer systems, minicomputers, mainframe computers, as well as personal computers, hand-held computing devices, microprocessor-based and/or programmable consumer electronics, and the like, each of which may operatively communicate with one or more associated devices. The illustrated aspects of the claimed subject matter may also be practiced in distributed computing environments where certain tasks are performed by remote processing devices that are linked through a communications network. However, some, if not all, aspects of the subject innovation may be practiced on stand-alone computers. In a distributed computing environment, program modules may be located in local and/or remote memory storage devices.

FIG. 9 is a schematic block diagram of a sample-computing environment 900 with which the claimed subject matter can interact. The system 900 includes one or more client(s) 910. The client(s) 910 can be hardware and/or software (e.g., threads, processes, computing devices). The system 900 also includes one or more server(s) 920. The server(s) 920 can be hardware and/or software (e.g., threads, processes, computing devices). The servers 920 can house threads to perform transformations by employing the subject innovation, for example.

One possible communication between a client 910 and a server 920 can be in the form of a data packet adapted to be transmitted between two or more computer processes. The system 900 includes a communication framework 940 that can be employed to facilitate communications between the client(s) 910 and the server(s) 920. The client(s) 910 are operably connected to one or more client data store(s) 940 that can be employed to store information local to the client(s) 910. Similarly, the server(s) 920 are operably connected to one or more server data store(s) 930 that can be employed to store information local to the servers 920.

With reference to FIG. 10, an exemplary environment 1000 for implementing various aspects of the claimed subject matter includes a computer 1012. The computer 1012 includes a processing unit 1014, a system memory 1016, and a system bus 1018. The system bus 1018 couples system components including, but not limited to, the system memory 1016 to the processing unit 1014. The processing unit 1014 can be any of various available processors. Dual microprocessors and other multiprocessor architectures also can be employed as the processing unit 1014.

The system bus 1018 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1016 includes volatile memory 1020 and nonvolatile memory 1022. The basic input/output system (BIOS), containing the basic routines to transfer information between elements within the computer 1012, such as during start-up, is stored in nonvolatile memory 1022. By way of illustration, and not limitation, nonvolatile memory 1022 can include read only memory (ROM), programmable ROM (PROM), electrically programmable ROM (EPROM), electrically erasable programmable ROM (EEPROM), or flash memory. Volatile memory 1020 includes random access memory (RAM), which acts as external cache memory. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), Rambus direct RAM (RDRAM), direct Rambus dynamic RAM (DRDRAM), and Rambus dynamic RAM (RDRAM).

Computer 1012 also includes removable/non-removable, volatile/non-volatile computer storage media. FIG. 10 illustrates, for example a disk storage 1024. Disk storage 1024 includes, but is not limited to, devices like a magnetic disk drive, floppy disk drive, tape drive, Jaz drive, Zip drive, LS-100 drive, flash memory card, or memory stick. In addition, disk storage 1024 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1024 to the system bus 1018, a removable or non-removable interface is typically used such as interface 1026.

It is to be appreciated that FIG. 10 describes software that acts as an intermediary between users and the basic computer resources described in the suitable operating environment 1000. Such software includes an operating system 1028. Operating system 1028, which can be stored on disk storage 1024, acts to control and allocate resources of the computer system 1012. System applications 1030 take advantage of the management of resources by operating system 1028 through program modules 1032 and program data 1034 stored either in system memory 1016 or on disk storage 1024. It is to be appreciated that the claimed subject matter can be implemented with various operating systems or combinations of operating systems.

A user enters commands or information into the computer 1012 through input device(s) 1036. Input devices 1036 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1014 through the system bus 1018 via interface port(s) 1038. Interface port(s) 1038 include, for example, a serial port, a parallel port, a game port, and a universal serial bus (USB). Output device(s) 1040 use some of the same type of ports as input device(s) 1036. Thus, for example, a USB port may be used to provide input to computer 1012, and to output information from computer 1012 to an output device 1040. Output adapter 1042 is provided to illustrate that there are some output devices 1040 like monitors, speakers, and printers, among other output devices 1040, which require special adapters. The output adapters 1042 include, by way of illustration and not limitation, video and sound cards that provide a means of connection between the output device 1040 and the system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. The remote computer(s) 1044 can be a personal computer, a server, a router, a network PC, a workstation, a microprocessor based appliance, a peer device or other common network node and the like, and typically includes many or all of the elements described relative to computer 1012. For purposes of brevity, only a memory storage device 1046 is illustrated with remote computer(s) 1044. Remote computer(s) 1044 is logically connected to computer 1012 through a network interface 1048 and then physically connected via communication connection 1050. Network interface 1048 encompasses wire and/or wireless communication networks such as local-area networks (LAN) and wide-area networks (WAN). LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1050 refers to the hardware/software employed to connect the network interface 1048 to the bus 1018. While communication connection 1050 is shown for illustrative clarity inside computer 1012, it can also be external to computer 1012. The hardware/software necessary for connection to the network interface 1048 includes, for exemplary purposes only, internal and external technologies such as, modems including regular telephone grade modems, cable modems and DSL modems, ISDN adapters, and Ethernet cards.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A system that facilitates querying data, comprising:
an interface component that receives data related to querying content; and
a rank component that employs a content rank based on a quantitative measurement to ascertain an objective ranking of the queried content.

2. The system of claim 1, the content relates to at least one of a book, a magazine, a newspaper, an article, a periodical, a comic book, a literary work, a written work, a newspaper article, a magazine article, a newspaper article, a portion of literature, a poem, a manual, a portion of data associated with literature, a portion of media, a portion of music, a movie, a portion of a movie, a video, a portion of video, and a portion of data that is queried.

3. The system of claim 1, the quantitative measurement is at least one of a number of web pages that mention the content, a measured importance of web pages that mention the content, a number of library holdings for the content, a library circulation number for the content, sales data for the content, a peer group review of the content, and a peer group rating for the content.

4. The system of claim 3, the quantitative measurement is at least one of a popularity determination correlating to a sect of users, a number of residual works, a number of related works, a number of unique institutional holdings, a number of reviews, a number of creative entity holdings, a creative entity circulation number, a creative entity web mentions, a creative entity web mentions, a creative entity sales statistics, a creative entity mentioned in book indices, a relationship with a particular creative entity, a newsgroup opinion, a forum opinion, and an incoming link to content.

5. The system of claim 4, the creative entity is a person associated with developing the content.

6. The system of claim 5, the creative entity is at least one of an author, a composer, a director, a producer, an actor, an actress, a journalist, a poet, a screen-writer, a special effects artist, an artist, a librarian, a blogger, and a photographer.

7. The system of claim 1, further comprising a dynamic component that provides a query result.

8. The system of claim 7, the dynamic component provides the query result utilizing at least a portion of the content rank.

9. The system of claim 8, the content rank is created independent of the query result.

10. The system of claim 9, further comprising a plurality of query results provided by the content rank and the hyperlink-based ranking technique.

11. The system of claim 1, further comprising a query result including the content rank to enable objective evaluation of such query result.

12. The system of claim 1, further comprising an update component that enables continuous and seamless upgrading of at least one quantitative measurement utilized to create the content rank.

13. The system of claim 12, the update component provides at least one of a disparate version of a quantitative measurement and a replacement quantitative measurement.

14. The system of claim 1, further comprising a data collection engine that gathers data associated with at least one quantitative measurement related to content.

15. The system of claim 14, further comprising an organizational component that organizes data collected by the data collection engine, the data is normalized to create the content rank.

16. The system of claim 15, further comprising a hook component that allows at least one search component to latch into the rank component to enable access to the generated content rank.

17. A computer-implemented method that facilitates providing query results in an objective manner, comprising:
receiving query data related to a portion of content; and
creating a content rank based on a quantitative measurement for an objective evaluation of content.

18. The method of claim 17, the content relates to at least one of a book, a magazine, a newspaper, an article, a periodical, a comic book, a literary work, a written work, a newspaper article, a magazine article, a newspaper article, a portion of literature, a poem, a manual, a portion of data associated with literature, a portion of media, a portion of music, a movie, a portion of a movie, a video, a portion of video, and a portion of data that is queried.

19. The method of claim 17, the quantitative measurement is at least one of a number of web pages that mention the content, a measured importance of web pages that mention the content, a number of library holdings for the content, a library circulation number for the content, sales data for the content, a peer group review of the content, a peer group rating for the content, a popularity determination correlating to a sect of users, a number of residual works, a number of related works, a number of unique institutional holdings, a number of reviews, a number of creative entity holdings, a creative entity circulation number, a creative entity web mentions, a creative entity web mentions, a creative entity sales statistics, a creative entity mentioned in book indices, a relationship with a particular creative entity, a newsgroup opinion, a forum opinion, and an incoming link to content.

20. A computer-implemented system that facilitates querying data, comprising:
means for receiving data related to querying content; and
means for employing a content rank based on a quantitative measurement to ascertain an objective ranking of the queried content.
